(19) United States
(12) Patent Application Publication
(10) Pub. No.: US 2008/0005295 A1
(43) Pub. Date: Jan. 3, 2008

(54) Managing Web Service Access via a Portal

(75) Inventors: Chris E. Burroughs, Woodinville, WA (US); Michael J. Miles, Duvall, WA (US); Stefan D. Weitz, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/428,257

(22) Filed: Jun. 30, 2006

(51) Int. Cl. G06F 15/173

(52) U.S. Cl. 709/223

(57) ABSTRACT

Web service management techniques involving a portal are described. In an implementation, a method includes providing a portal, through which, web services are accessible to a client. Access to the web services is managed such that when the client is not associated with a current subscription to a provider of the portal, access is limited to the web services specified by a list.

### BACKGROUND

The availability of wireless networks to the public is ever increasing. For example, a user of a client device (e.g., a laptop computer, personal digital assistant, etc.) having wireless functionality may access wireless network at a coffee shop, between flights at an airport, and so on. Through access to the wireless network, the user is typically provided with access to the Internet, such as to read email, “surf the net”, chat, and so forth.

Traditional providers of wireless networks, however, did not provide access to this functionality (e.g., to access the Internet) until the user obtained a subscription. For example, the user may create an account by supplying a user name and password. The user may then provide payment information to obtain a current subscription to access the services offered by the provider for a predetermined amount of time, such as for 24 hours, an auto-renewing month-to-month subscription, and so forth. Use of this traditional model, however, typically limited the opportunities of the provider to collect revenue and therefore did not provide for other revenue streams. Although a technique was developed to provide additional source of revenue by including advertisements, these advertisements were limited to view on an initial login screen and could not access functionality beyond the login screen.

### SUMMARY

Web service management techniques involving a portal are described. In an implementation, a method includes providing a portal, through which, web services are accessible to a client. Access to the web services is managed such that when the client is not associated with a current subscription to a provider of the portal, access is limited to the web services specified by a list.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items

FIG. 1 is an illustration of an environment in an exemplary implementation that is operable to employ web service access management techniques via a portal.

FIG. 2 is an illustration of a system in an exemplary implementation showing a portal and client of FIG. 1 in greater detail.

FIG. 3 is an illustration of an exemplary implementation of a portal page as displayed by a display device of the client of FIG. 2.

FIG. 4 is a flow diagram depicting a procedure in an exemplary implementation in which a portal is provided to manage access of a client to web services based on an association of the client with a current subscription to a provider of the portal.

FIG. 5 is a flow diagram depicting a procedure in an exemplary implementation in which client interaction with links to permissible and impermissible web services is managed.

### DETAILED DESCRIPTION

Overview

The availability of wireless networks to the public is ever increasing, such as to provide wireless access to the Internet in a wide variety of locations. Traditional providers of wireless networks, however, did not provide access to this functionality (e.g., to access the Internet) until the user obtained a subscription from the provider. Although this protected the interests of the provider in collecting revenue from the user, these traditional techniques did not address other sources of revenue that could be collected.

One traditional technique was developed, in which, providers offered a limited area to let non-subscribers initially access their service. Traditionally, this was accomplished by setting up a “walled garden” which was a web service that restricted connectivity to the Internet to the walled garden. Therefore, these walled gardens blocked the user from accessing functionality “outside” of the walled garden until the user paid the provider a fee for full Internet access.

However, this approach limited monetization strategies that could be employed by the providers of the walled gardens. For example, since access to the broader Internet was restricted, advertisements were limited to display within the walled garden. Therefore, if the user selected (e.g., “clicked”) an advertisement in the walled garden, the user was be prompted to pay the provider for full internet access. If the user did not pay, the user was denied access. Thus, typical users would forgo interaction with the advertisements because they did not want to pay a fee to “see a commercial” or otherwise view additional information provided by the advertiser. Therefore, this traditional monetization strategy restricted display of information to within the walled garden, such as through the use of traditional banners and other advertisements. Additionally, monetization of these advertisements relied on an estimate of how many people accessed the walled garden and saw the advertisement. While this has been used successfully by a variety of different providers, other techniques may provide additional flexibility that could be desirable to advertisers, such as a “pay-per-click” strategy.

Accordingly, techniques are described in which providers may offer a portal to act as a “walled garden” for non-subscribers while at the same time allowing dynamic “punch through”. For example, a user may “click” on an advertisement to view additional information “outside” of the traditional walled garden. In a practical sense, this means a user can be served a number of advertisements within the portal environment, and may click on those advertisements to view additional information without requiring the user to pay for full network access. Thus, these techniques provide for effective monetization of the portal beyond traditional techniques which limited display to within the walled garden, such as banner advertisements and so on.

Furthermore, these techniques may offer significant benefit to advertisers. For example, an advertiser that chooses to advertise in the portal environment may give users access to the advertiser's domain. This is a competitive advantage for advertisers as those advertisers who choose not to advertise using the portal environment will not be accessible. A variety of techniques may be used to provide a portal environment, examples of which may be found in relation to the discussion of the following figures.

In the following discussion, an exemplary environment is first described that is operable to perform web service management techniques. Exemplary procedures and user interfaces are then described that may be employed in the exemplary environment, as well as in other environments.

Exemplary Environment

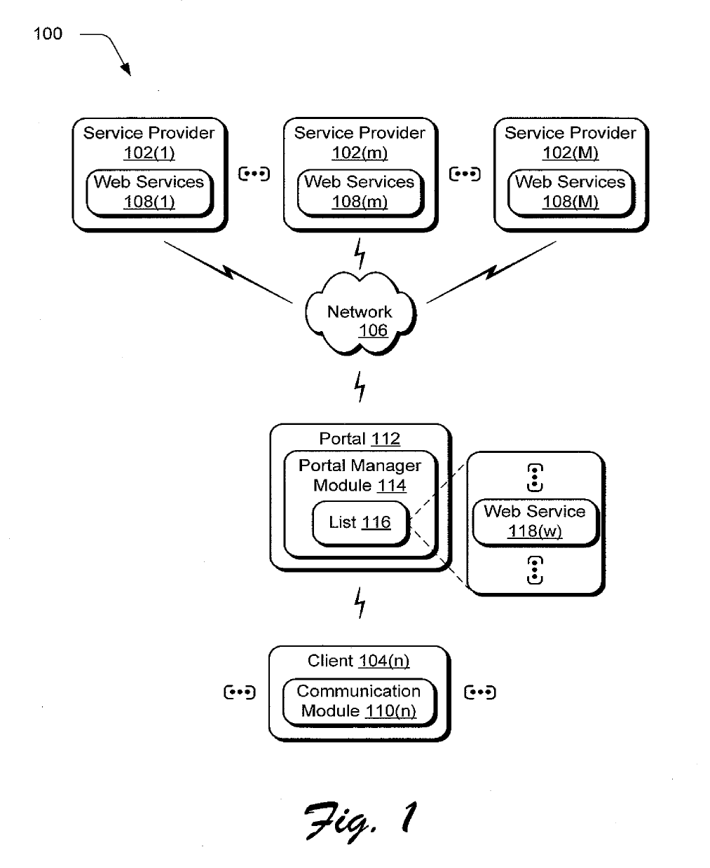

FIG. 1 is an illustration of an environment 100 in an exemplary implementation that is operable to employ web service access management techniques via a portal. The illustrated environment 100 includes a plurality of service providers 102(1), . . . , 102(m), . . . , 102(M) and one or more clients 104(n) (where “n” can be any integer from one to “N”) that are communicatively coupled, one to another, via a network 106. In the following discussion, the client 104(n) may be representative of one or more entities, and therefore reference may be made to a single entity (e.g., the client 104(n)) or multiple entities (e.g., the clients 104(n), the plurality of clients 104(n), and so on).

The clients 104(n) may be configured in a variety of ways for network 106 access. For example, one or more of the clients 104(n) may be configured as a client device, such as a desktop computer, a mobile station, an entertainment appliance, a set-top box communicatively coupled to a display device, a wireless phone, a game console, and so forth. Thus, the clients 104(n) may range from full resource devices with substantial memory and processor resources (e.g., personal computers, game consoles) to low-resource devices with limited memory and/or processing resources (e.g., traditional set-top boxes, hand-held game consoles). The clients 104(n), in portions of the following discussion, may also relate to a person and/or entity that operate the clients. In other words, one or more of the clients 104(n) may describe logical clients that include users, software, and/or devices.

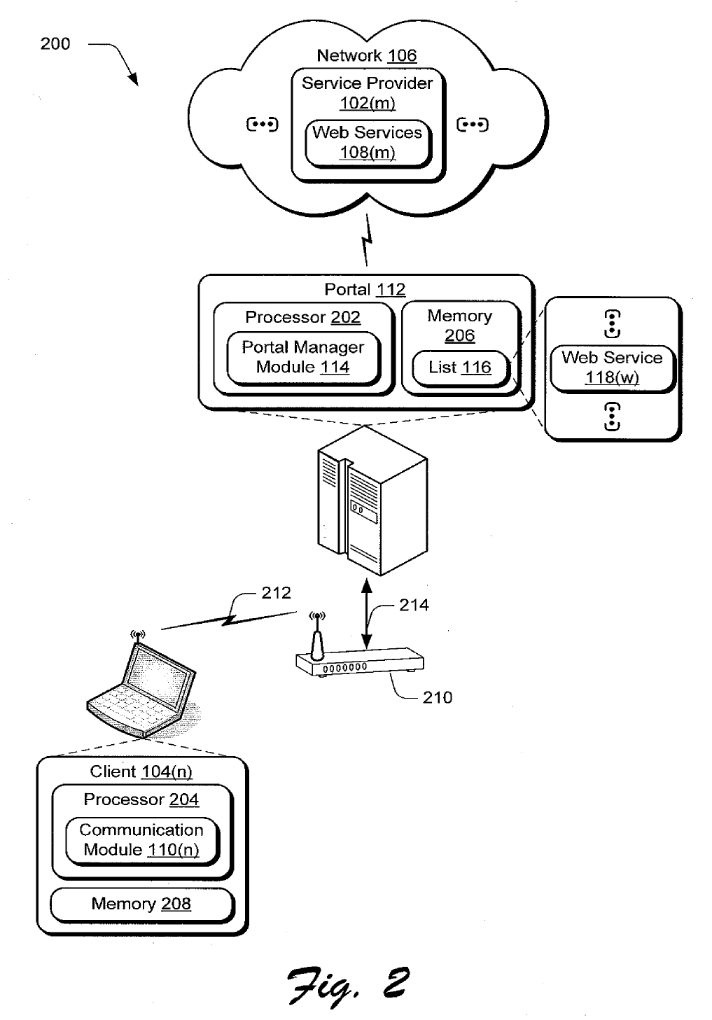

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks, further discussion of which may be found in relation to FIG. 2.

Each of the service providers 102(1)-102(M) is illustrated as including one or more respective web services 108(1)-108(M). The web services 108(1)-108(M) may be configured in a variety of ways. For example, the web services 108(1)-108(M) may be configured to send and receive email, provide instant messaging, web searching, productivity applications (e.g., word processors, spreadsheets, presentations, etc.), games, and other resources.

To access the web services 108(1)-108(M), the client 104(n) includes a communication module 110(n). The communication module 110(n) is representative of an executable module that is configured to communicate over the network 106. For example, the communication module 110(n) may be configured as a web browser that allows the client 104(n) to “surf” the Internet. In another example, the communication module 110(n) is configured as a “smart” client module that is configured to provide other network functionality as a part of its operation, such as an instant messaging module, an email module, an online banking module, and so on. A wide variety of other examples are also contemplated.

The environment 100 is further illustrated as including a portal 112 and a portal manager module 114 to manage access of the client 104(n) to the service providers 102(1)-102(M), and more particularly the web services 108(1)-108(M) of the respective service providers 102(1)-102(M). For example, the portal 112 may be employed by an Internet service provider (ISP) to manage access of the client 104(n) to the network 106. The portal 112 may be configured in a variety of ways, such as included as a part of a wireless access point, a stand-alone entity (e.g., implemented by one or more computers) that filters requests to an ISP, as part of a server farm of the ISP itself, and so forth.

The portal manager module 114 is representative of functionality that dynamically manages access to the web services 108(1)-108(M) without the user obtaining a subscription to a provider of the portal 112. Additionally, the access may be provided without authenticating the client 104(n), such as by providing a user name, password, and so on. The portal 112, for instance, may be used to limit broad access to the Internet and dynamically determine which network addresses (e.g., resulting from user “clicks”) are permitted to result in being taken “outside” of the portal 112. In this way, user request may be allowed to “punch through” the portal 112 for a variety of reasons, such as through linking to permissible advertisements, to access functionality of a provider of the portal 112, and so on.

The portal 112, for instance, may utilize a list 116 of web services 118(w) (where “w” can be any integer from one to W) that are permitted to be accessed when the client 104(n) does not have a current subscription, is not authenticated, and so on. For example, the list 116 may reference web services 118(w) that are owned by a provider of the portal 112, web services owned by advertisers (e.g., service providers 102(1)-102(M)) that have paid a provider of the portal 112 for inclusion on the list 116, and so on. The portal manager module 114, when executed, may then determine whether a requested web service is permitted to be accessed by the client 104(n) in its current state with respect to the portal 112, e.g., has a current subscription, is authenticated, and so on. When the client 104(n) is authenticated, has a current subscription, and so on, access to web services that are not included on the list 116 may be provided by the portal 112. In this way, the portal 112 provides a variety of techniques that may be used to generate revenue, further discussion of which may be found in relation to the following figures.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 112(m), 114(n). The features of the techniques to manage web service access described below are platform-independent, meaning that the techniques may be implemented on a variety of commercial computing platforms having a variety of processors.

FIG. 2 illustrates a system 200 in an exemplary implementation showing the client 104(n) and the portal 112 of FIG. 1 in greater detail. The portal 112 is illustrated in FIG. 2 as a stand-alone system being implemented by a server and the client 104(n) is illustrated as a client device, each of which having respective processors 202, 204 and memory 206, 208.

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 206, 208 is shown, respectively, for the portal 112 and the client 104(n), a wide variety of types and combinations of memory may be employed, such as random access memory (RAM), hard disk memory, removable medium memory, and other types of computer-readable media.

The client 104(n) is illustrated as being communicatively coupled to the portal 112 via a wireless access point 210. The wireless access point 210 may be configured in a variety of ways to provide a wireless connection 212 with the client 104(n), such as through compliance with IEEE 802.11 standards and so on. The wireless access point 210 is also configured to provide a network connection 214 with the portal 112, which may be a wired or wireless connection, or a combination thereof.

In the illustration of FIG. 2, the client 104(n) communicates with the wireless access point 210 by executing the communication module 110(n), such as to negotiate policies and protocols used to form the connection 212. The wireless access point 210 is configured to direct access of the client 104(n) with the network 106 through the portal 112, such as by “pointing” to a network address of the portal 112.

The portal 112 is illustrated as executing the portal manager module 114 on the processor 202, which is also storable in memory 206 along with the list 116. As before, the portal manager module 114 is executable to manage access of the client 104(n) to the service providers 102(m) and web services 108(m) “on the cloud”, i.e., accessible over the network 106 by the client 104(n) through the portal 112. The portal 112 may provide this access in a variety of ways, such as through interaction with a user interface provided by the portal 112.

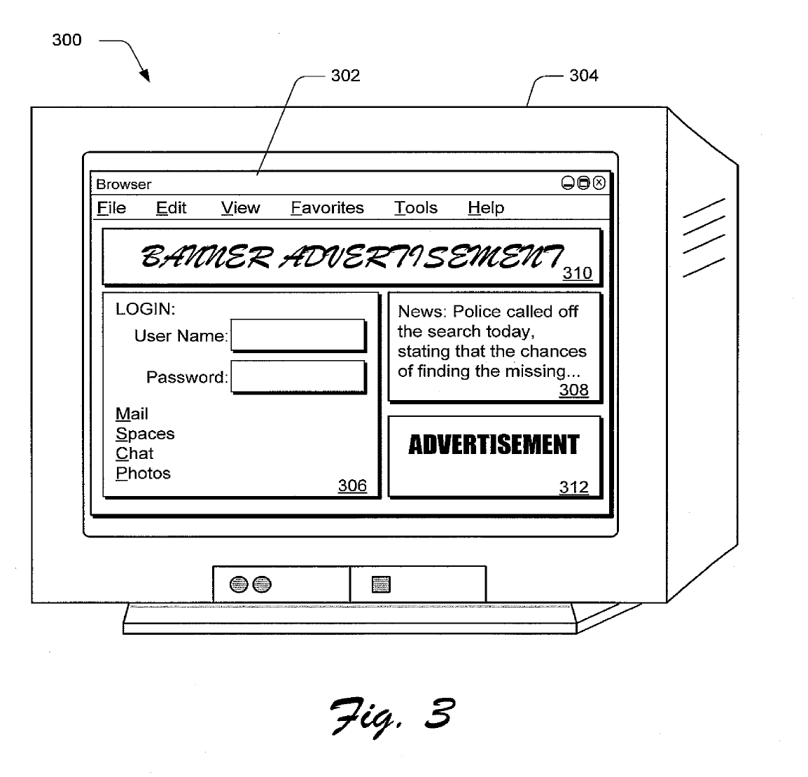

FIG. 3, for instance, illustrates an exemplary implementation 300 of a portal page 302 as displayed by a display device 304 of the client 104(n) of FIG. 2. The portal page 302 is illustrated as being output through a browser and includes a login section 306, via which, a user may be authenticated with the portal 112. The portal page 302 may also include information obtained from over the network 106 to provide a “richer” experience to a user, such as through the news section 308.

The user may browse the information contained on the portal page 302 and be presented with advertisements during this experience. The advertisements may be provided in a variety of ways, such as a banner advertisement 310, a text advertisement 312, a video advertisement, and so on. The advertisements may also be configured, such that, a user may select the advertisement to navigate to information related to the advertisement.

The user, for instance, may select the banner advertisement 310, which causes a network address (e.g., a uniform resource locator) of the advertisement to be passed to the portal manager module 114. The portal manager module 114 may then attempt to match the requested network address with network addresses of web services 118(w) in a list 116 that are permitted to be accessed. When the requested network address is matched, the user is directed to the requested network address. When the network address does not match, however, the user may be directed to a page that requests billing information from the user in order to obtain “full” network access. Similar techniques may be employed when the user attempts to directly navigate to a web service.

When the network address does match, the portal manager module 114 may track this usage and charge an advertiser associated with the advertisement for the access. Thus, a provider of the portal 112 may avail themselves of an additional stream of revenue by providing a “punch through” to other functionality desired by the advertiser, but still limit overall network access until the user obtains a subscription. Further discussion of subscriptions, web service access and advertisements may be found in relation to the following procedures.

Exemplary Procedures

The following discussion describes web service access management techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2 and the implementation 300 of a user interface of FIG. 3.

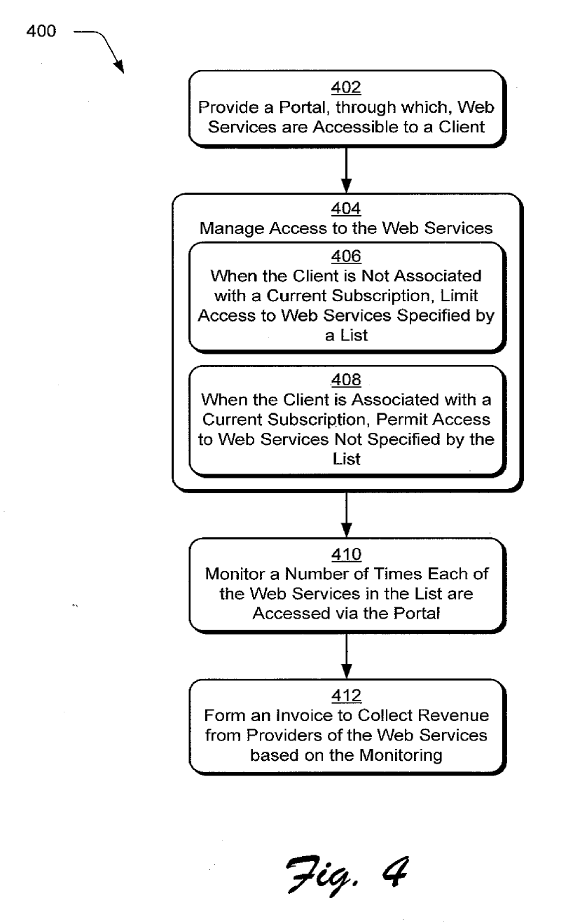

FIG. 4 depicts a procedure 400 in an exemplary implementation in which a portal is provided to manage access of a client to web services based on an association of the client with a current subscription to a provider of the portal. A portal is provided, through which, web services are accessible to a client (block 402). For example, the portal may be provided by an Internet service provider (ISP) which also provides wireless access points as described in relation to FIG. 2. A variety of other examples are also contemplated, such as a stand-alone portal provided by a “dial-up” ISP.

Access to the web services is managed (block 404) through use of the portal. When the client is not associated with a current subscription, access is limited to web services specified by a list (block 406). When the client is associated with a current subscription, access is permitted to web services that are not specified by the list (block 408). Thus, the clients association with the provider of the portal may be used to manage access to web services that is permitted by the client.

For example, a client may access a wireless access point (WAP), such as a WAP located at a coffee shop, airport, and so on. The WAP directs the client to the portal 112, which provides a portal page 302 for output by the client. When the client is not associated with a current subscription (e.g., the client has not yet been authenticated, the subscription has expired, and so on), the portal 112 may permit the client 104(n) to access web services 118(w) specified in the list 116. The list for instance, may specify web services that the provider of the portal 112 collects revenue by providing the access, such as advertisement revenue, “pay-per-click” revenue, and so on. Web services that are not included on the list, however, are prevented from being accessed. Therefore, the provider of the portal 112 may preserve a subscription monetization strategy to provide network access to clients as well as other monetization strategies.

The portal, for instance, may monitor a number of times each of the web services in the list are accessed via the portal (block 410). The portal may then form an invoice to collect revenue from providers of the web services (e.g., the service providers 102(1)-102(M) of the respective web services 108(1)-108(M)) based on the monitoring (block 412). The invoice, for instance, may include an amount that is to be charged to each of the respective service providers 102(1)-102(M) on a “per click” basis, e.g., a number of times each web service 108(1)-108(M) was accessed using a respective advertisement in the portal page 302. A variety of other instances of monetization strategies are also contemplated.

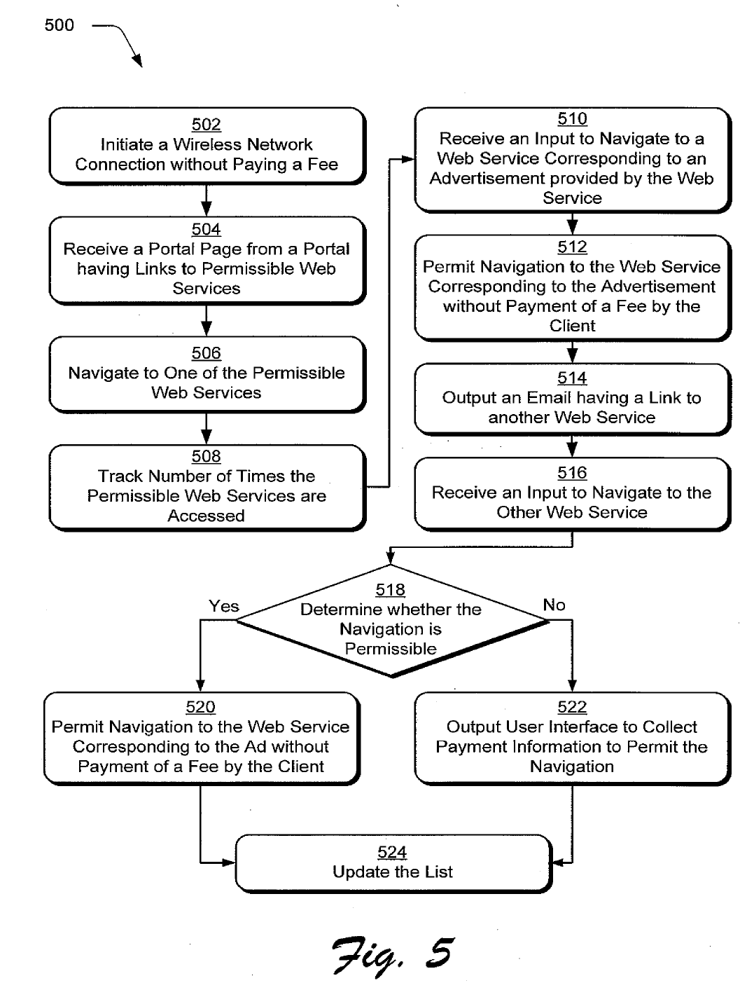

FIG. 5 depicts a procedure 500 in an exemplary implementation in which client interaction with links to permissible and impermissible web services is managed. A wireless network connection is initiated without paying a fee (block 502). The client 104(n), for example, may access a wireless access point 210 and be directed to a portal 112. The client may then receive a portal page 302 from the portal 112 having links to permissible web services (block 504).

The portal page 302, for instance, may have links to mail web services, “spaces” web services, “chat” web services (i.e., instant messaging) and “photo” web services as illustrated in the portal page 302 of FIG. 3. These web services may be “permissible” for a variety of reasons, such as services that the provider of the portal collects advertisement revenue. The client may then navigate to one of the permissible web services (block 506) using the portal page 302, such as by selecting a “mail” link to an email web service. The portal 112 may manage this access as previously described. For example, the portal manager module 114, when executed, may determine whether the requested web service is included on the list 116, and if so, permit navigation.

While interacting with the “permissible” web service, an input may be received to navigate to a web service corresponding to an advertisement provided by the web service (block 510). The client, for instance, may interact with the mail web service and notice an advertisement of interest and therefore select the advertisement to request additional information that is to be provided via another web service. The selection may then be processed by the portal 112 to determine whether access to that other web service is to be permitted.

In this example, navigation is permitted to the web service that corresponds to the advertisement without payment of a fee by the client (block 512). Thus, the client may access the web service without having a current subscription as was specified using traditional access and monetization techniques. Thus, the portal may manage interaction with web services 118(w) included in the list that are apart from the portal 112, such as web services that are provided by service providers that are different than the provide of the portal 112.

Continuing with the previous example, a user may output an email having a link to yet another web service (block 514) and request navigation to that other web service. Accordingly, the portal 112 may receive the input to navigate to the other web service (block 516) and determine whether the navigation is permissible (decision block 518). If so (“yes” from decision block 518), navigation is permitted to the web service that corresponds to the advertisement without payment of a fee by the client (block 520). Thus, the client may also be given access to web services that are included in links that did not originate in the portal page 302 itself, but rather were obtained using other techniques, such as through manual entry by the client, selection of a link in content received through the portal page 302, and so on.

When navigation is not permissible (“no” from decision block 518), a user interface is output to collect payment information to permit the navigation (block 522). The user interface, for instance, may be configured to make a subscription of the client to a wireless network service provider “current” by providing up-do-date payment information, such as a name, billing address and credit card information. In this way, a provider of the portal 112 may still provide access to other web services not included on a list 116 and collect revenue for providing this access.

The list 116 used by the portal 112 may also be updated (block 524). For example, a provider of the portal 112 may send an updated list of advertisers web services for a current payment period, updated network addresses of the web services, and so on. Thus, the portal 112 may be kept “up-to-date” to manage web service access.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
providing a portal, through which, web services are accessible to a client; and
managing access to the web services such that when the client is not associated with a current subscription to a provider of the portal, access is limited to the web services specified by a list.

2. A method as described in claim 1, wherein:
at least one of the web services that is included on the list is associated with an advertisement that is provided to the client via the portal;
the advertisement is selectable to navigate to the at least one web service.

3. A method as described in claim 1, wherein the provider is an Internet service provider.

4. A method as described in claim 1, wherein the portal is accessible to the client via a wireless network connection provided at least in part by a wireless access point.

5. A method as described in claim 1, wherein the managing includes limiting access to the web services that are included on the list when the client is not authenticated by the provider using a user name and password.

6. A method as described in claim 1, wherein:
at least one of the web services that are included on the list includes a link to another web service that is not included on the list; and
the managing includes preventing access by the client to the other web service when the client is not associated with the current subscription.

7. A method as described in claim 1, wherein the subscription specifies a period of time, during which, access is permitted to at least one web service that is not included on the list.

8. A method as described in claim 1, wherein the subscription is provided for a fee and access to the web services included in the list is provided free-of-charge to the client.

9. A method as described in claim 1, wherein the managing includes:
determining whether a network address of a particular said web service is included in the list; and
when the network address is included in the list, permitting access to the particular said web service.

10. A method as described in claim 1, further comprising:
monitoring a number of times access is provided to the web services included on the list; and
collecting revenue from providers of the web services based on the monitoring.

11. One or more computer-readable media comprising executable instruction that, when executed, direct a computer to provide a portal page of a service provider that:
limits access of a client to a collection of web services, at least one of which is accessible via an advertisement that is displayable by the portal page, when the client is not associated with a current subscription to the service provider; and
permits access to web services that are not included in the collection when the client is associated with the current subscription.

12. One or more computer readable media as described in claim 11, wherein when the client is not authenticated by the service provider, the client is permitted to access to the collection of web services.

13. One or more computer readable media as described in claim 11, wherein the collection is specified via a list and the computer executable instructions further direct the computer to update the list using data received via a network.

14. One or more computer readable media as described in claim 11, wherein the computer executable instructions further direct the computer to track a number of accesses achieved to each of the web services in the collection.

15. One or more computer readable media as described in claim 14, wherein the computer executable instructions further direct the computer to output an invoice to collect revenue based on the tracked number.

16. A portal comprising:
a processor; and
memory configured to maintain a list of web services and a module that is executable on the processor to:
service requests received from a client via a wireless access point to access one or more web services;
permit the client to access the web services included in the list when the client has not been authenticated; and
provide a user interface, via which, payment information is to be received to access web services that are not included on the list.

17. A portal as described in claim 16, wherein the module is further executable to determine whether the client is associated with current payment information, and if so, permit access to the web services that are not included on the list.

18. A portal as described in claim 16, wherein the user interface is provided when the client is not associated with a current subscription.

19. A portal as described in claim 16, wherein access to at least one of the network addresses in the list is provided via an advertisement.

20. A portal as described in claim 16, wherein access to the network addresses in the list is provided to the client free-of-charge.
